(19) United States
(12) Patent Application Publication
(10) Pub. No.: US 2019/0227176 A1
(43) Pub. Date: Jul. 25, 2019

(54) GNSS LOCALIZATION USING VEHICLE SENSORS

(71) Applicant: GM GLOBAL TECHNOLOGY OPERATIONS LLC, Detroit, MI (US)

(72) Inventors: Xiaofeng F. Song, Novi, MI (US); Bing Deng, Bloomfield Hills, MI (US); Jun Yuan, Shanghai (CN)

(21) Appl. No.: 15/877,610

(22) Filed: Jan. 23, 2018

(51) Int. Cl. G01S 19/07; B60W 40/105; G01C 21/00

(52) U.S. Cl. CPC G01S 19/07; B60W 40/105; G01C 21/005; B60W 2750/40; B60W 2520/12; B60W 2420/42; B60W 2520/28

(57) ABSTRACT

A system and method of determining a geographical location of a vehicle. The method carried out by the system includes: obtaining geographical coordinates of the vehicle; determining a lateral ground displacement within a roadway on which the vehicle is traveling; receiving geographical map data that includes one or more roadways including the roadway on which the vehicle is traveling; and adjusting the geographical coordinates of the vehicle based on the lateral ground displacement and the geographical map data.

The present invention relates to adjusting geographical coordinates of a vehicle based on information obtained by one or more vehicle sensors.

Vehicles include hardware and software capable of obtaining and processing various information, including information that is obtained by vehicle system modules (VSMs). One such VSM is a global navigation satellite system (GNSS) receiver that can obtain or determine geographical coordinates of the vehicle. The geographical coordinates representing the vehicle's location can be used for carrying out autonomous or semi-autonomous operations of the vehicle and, in such cases, it is desirable to achieve accurate geographical coordinates. However, some countries (or geopolitical regions) may require certain operations to be performed on the determined GNSS coordinates so as to increase national security. For example, in some countries “geo-shifting” measures are required, which includes executing the government's proprietary geo-shifting application on GNSS receivers. This geo-shifting application entails shifting the geographic coordinates by a random value so that the accuracy of the geographical coordinates is reduced. This can negatively impact the accuracy of vehicle navigation and other vehicle functionality that uses GNSS coordinates.

### SUMMARY

According to one aspect of the invention, there is provided a method of determining a geographical location of a vehicle, the method including: obtaining geographical coordinates of the vehicle; determining a lateral ground displacement within a roadway on which the vehicle is traveling; receiving geographical map data that includes one or more roadways including the roadway on which the vehicle is traveling; and adjusting the geographical coordinates of the vehicle based on the lateral ground displacement and the geographical map data.

According to various embodiments, this method may further include any one of the following features or any technically-feasible combination of some or all of these features:
the obtaining step includes receiving a plurality of global navigational satellite (GNSS) signals from a plurality of GNSS satellites and determining a geographical location based on the received GNSS signals;
the determining step includes: obtaining images of the roadway on which the vehicle is traveling using at least one camera or light sensor that is installed on the vehicle as part of vehicle electronics; and processing the obtained images to determine the lateral ground displacement of the vehicle within the roadway on which the vehicle is traveling;
the vehicle electronics includes a plurality of cameras installed on the vehicle and that are used to obtain the images of the roadway on which the vehicle is traveling;
applying geo-shifting to the geographical coordinates before the adjusting step;
the geo-shifting is imposed by a jurisdiction in which the vehicle is located;
obtaining vehicle dynamics information including vehicle speed information and vehicle heading information, wherein the adjusting step is based on the vehicle dynamics information;
the vehicle dynamics information further includes vehicle acceleration information and wherein the vehicle speed information is based on a vehicle wheel speed and/or a vehicle transverse speed;
the adjusting step includes using an extended Kalman filter to calculate new geographical coordinates based on the geographical coordinates, the vehicle dynamics information, and the vehicle lateral displacement; and/or
obtaining geographical roadway map information of a region surrounding the vehicle.

According to another aspect of the invention, there is provided a method of determining a geographical location of a vehicle, the method including: determining geographical coordinates of the vehicle using a global navigation satellite system (GNSS) receiver included in the vehicle, where the geographical coordinates are determined by receiving a plurality of GNSS signals from a constellation of GNSS satellites; shifting the geographical coordinates using geo-shifting techniques using the GNSS receiver; determining a lateral ground displacement within a roadway on which the vehicle is traveling using at least one camera installed on the vehicle; receiving geographical roadway map data that includes one or more roadways including the roadway on which the vehicle is traveling; obtaining vehicle dynamics information including a vehicle speed and a vehicle heading; and adjusting the geographical coordinates of the vehicle based on the lateral ground displacement and the geographical map data, wherein the adjusting includes using an extended Kalman filter to calculate new geographical coordinates based on the geographical coordinates, the vehicle dynamics information, and the vehicle lateral displacement.

According to various embodiments, this method may further include any one of the following features or any technically-feasible combination of some or all of these features:
the determining step includes: obtaining images of the roadway on which the vehicle is traveling using a first one of the at least one camera that is installed on the vehicle as part of vehicle electronics; and processing the obtained images to determine the lateral ground displacement of the vehicle within the roadway on which the vehicle is traveling, wherein the processing includes identifying lane markers or an edge of the roadway on which the vehicle is traveling;
applying geo-shifting to the geographical coordinates before the adjusting step.
the geo-shifting is imposed by a jurisdiction in which the vehicle is located;
obtaining vehicle dynamics information including vehicle speed information and vehicle heading information, wherein the adjusting step is based on the vehicle dynamics information;
the vehicle dynamics information further includes vehicle acceleration information and wherein the vehicle speed information is based on a vehicle wheel speed and/or a vehicle transverse speed;
sending the geographical coordinates or other geographical location information to a remote server; and/or
receiving update geographical roadway map data from the remote server.

According to yet another aspect of the invention, there is provided a vehicle electronics system, including: a global navigation satellite system (GNSS) receiver that is configured to receive GNSS signals from a constellation of GNSS satellites and to determine geographical coordinates based on the GNSS signals; at least one camera that is configured to capture images of the roadway; a wireless communications device that includes a processing device and memory, wherein the wireless communications device is configured to receive geographical roadway map data from a remote facility; wherein the vehicle electronics system is configured to: determine a lateral ground displacement within a roadway on which the vehicle is traveling by processing the captured images of the roadway; and adjust the geographical coordinates of the vehicle based on the lateral ground displacement and the geographical roadway map data.

According to various embodiments, this system may further include any one of the following features or any technically-feasible combination of some or all of these features:
the vehicle electronics system further includes a body control module that is configured to receive vehicle dynamics information from at least one of the following: a wheel speed sensor that is coupled to a wheel of the vehicle, a steering wheel angle sensor, a yaw rate sensor, and/or a throttle position sensor; and wherein the vehicle electronics system is further configured to adjust the geographical coordinates based on the vehicle dynamics information; and/or
the GNSS receiver is further configured to perform geo-shifting techniques on the geographical coordinates as imposed by a government of a geopolitical region in which the vehicle is located.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a flowchart of an embodiment of a method of determining a geographical location of a vehicle; and

FIG. 3 is a plot of the location of the vehicle, including the geographical coordinates of the vehicle and the geo-shifted geographical coordinates.

### DETAILED DESCRIPTION

The system and method described below enables a vehicle to determine and to adjust geographical coordinates of the vehicle based on information obtained from various vehicle sensors. In this way, the vehicle can perform self-localization of its actual position to thereby improve the accuracy of navigation, which may be particularly useful for autonomous or semi-autonomous driving. For example, the vehicle can use one or more cameras (or other sensors) to determine a vehicle lateral displacement of the vehicle among the roadway on which the vehicle is traveling. Additionally, the vehicle can use vehicle dynamics information, such as vehicle speed and vehicle heading, to adjust the geographical coordinates it uses for navigation. In one embodiment, the vehicle can receive geographical roadway map data, determine geographical coordinates of a vehicle using a plurality of global navigational satellite system (GNSS) signals, obtain vehicle lateral displacement and/or vehicle dynamics information, and adjust the geographical coordinates based on the obtained information. In a particular embodiment, the adjusting step can be carried out using an extended Kalman filter (EKF) that is at least partially based on the vehicle lateral displacement and/or the vehicle dynamics information, as discussed in more detail below. And, in some embodiments, the geographical coordinates may be geo-shifted so that the coordinates are less accurate, as may be required by the governments of some geopolitical regions. The system and method below can provide for determining geographical coordinates of the vehicle with improved accuracy so as to mitigate the effects of geo-shifting and/or other factors that may cause the geographical coordinates to be less accurate, such as noise or areas of poor global navigational satellite signal (GNSS) reception.

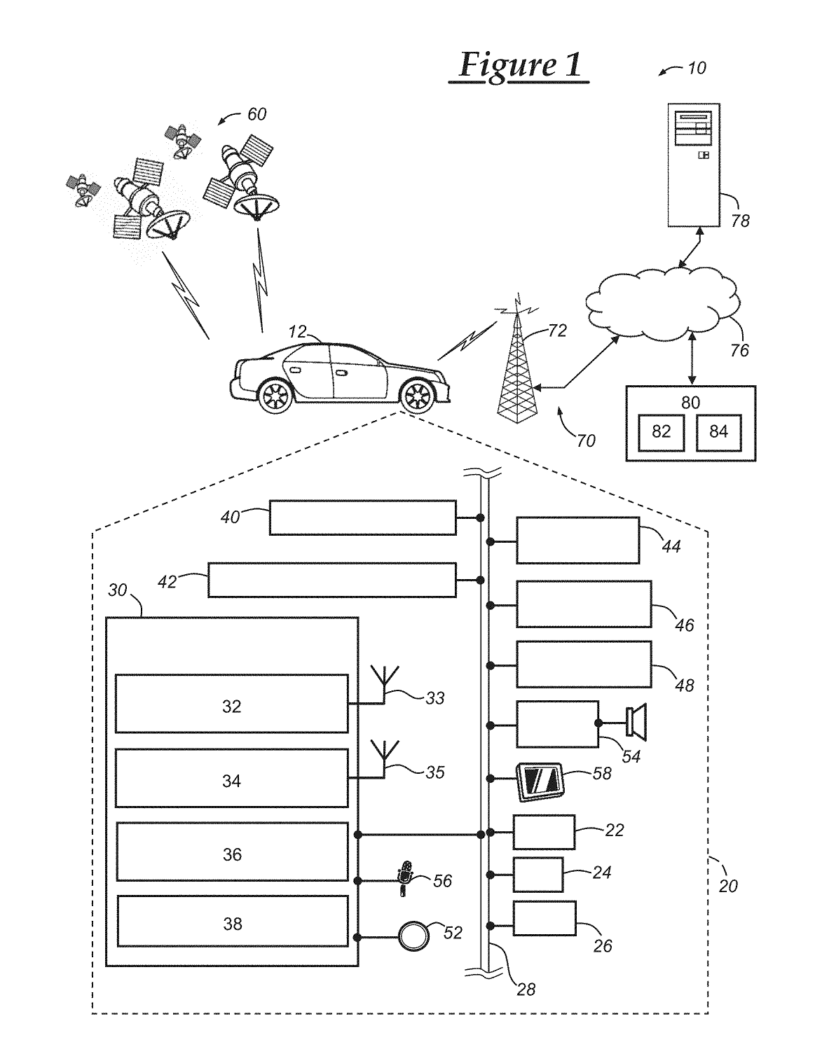

With reference to FIG. 1, there is shown an operating environment that comprises a communications system 10 and that can be used to implement the method disclosed herein. Communications system 10 generally includes a vehicle 12 with a wireless communications device 30 and VSMs 22-58, a constellation of global navigation satellite system (GNSS) satellites 60, one or more wireless carrier systems 70, a land communications network 76, a computer or server 78, and a vehicle backend services facility 80. It should be understood that the disclosed method can be used with any number of different systems and is not specifically limited to the operating environment shown here. Also, the architecture, construction, setup, and general operation of the system 10 and its individual components are generally known in the art. Thus, the following paragraphs simply provide a brief overview of one such communications system 10; however, other systems not shown here could employ the disclosed method as well.

Wireless carrier system 70 may be any suitable cellular telephone system. Carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the land network 76 or to connect the wireless carrier system with user equipment (UEs, e.g., which can include telematics equipment in vehicle 12). Carrier system 70 can implement any suitable communications technology, including GSM/GPRS technology, CDMA or CDMA2000 technology, LTE technology, etc. In general, wireless carrier systems 70, their components, the arrangement of their components, the interaction between the components, etc. is generally known in the art.

Apart from using wireless carrier system 70, a different wireless carrier system in the form of satellite communication can be used to provide uni-directional or bi-directional communication with the vehicle. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the vehicle 12 and the uplink transmitting station. If used, this satellite telephony can be utilized either in addition to or in lieu of wireless carrier system 70.

Land network 76 may be a conventional land-based telecommunications network that is connected to one or more landline telephones and connects wireless carrier system 70 to remote facility 80. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), or networks providing broadband wireless access (BWA), or any combination thereof.

Computers 78 (only one shown) can be some of a number of computers accessible via a private or public network such as the Internet. Each such computer 78 can be used for one or more purposes, such as a geographical map provider that supplies geographical maps over the Internet. Other such accessible computers 78 can be, for example: a service center computer where diagnostic information and other vehicle data can be uploaded from the vehicle; a client computer used by the vehicle owner or other subscriber for such purposes as accessing or receiving vehicle data or to setting up or configuring subscriber preferences or controlling vehicle functions; a car sharing server which coordinates registrations from a plurality of users who request to use a vehicle as part of a car sharing service; or a third party repository to or from which vehicle data or other information is provided, whether by communicating with the vehicle 12, remote facility 80, or both. A computer 78 can also be used for providing Internet connectivity such as DNS services or as a network address server that uses DHCP or other suitable protocol to assign an IP address to vehicle 12.

Remote facility 80 may be designed to provide the vehicle electronics 20 with a number of different system back-end functions through use of one or more electronic servers and, in many cases, may be a vehicle backend services facility that provides vehicle-related backend functionality. The remote facility 80 includes servers (vehicle backend services servers) 82 and databases 84, which may be stored on a plurality of memory devices. Also, remote facility 80 can include one or more switches, live advisors, an automated voice response system (VRS), all of which are known in the art. Remote facility 80 may include any or all of these various components and, preferably, each of the various components are coupled to one another via a wired or wireless local area network. Remote facility 80 may receive and transmit data via a modem connected to land network 76. Data transmissions may also be conducted by wireless systems, such as IEEE 802.11x, GPRS, and the like. Those skilled in the art will appreciate that, although only one remote facility 80 and one computer 78 are depicted in the illustrated embodiment, numerous remote facilities 80 and/or computers 78 may be used.

Servers 82 can be computers or other computing devices that include at least one processor and that include memory. The processors can be any type of device capable of processing electronic instructions including microprocessors, microcontrollers, host processors, controllers, vehicle communication processors, and application specific integrated circuits (ASICs). The processors can be dedicated processors used only for servers 82 or can be shared with other systems. The at least one processor can execute various types of digitally-stored instructions, such as software or firmware, which enable the servers 82 to provide a wide variety of services. This software may be stored in computer-readable memory such as any of the various types of RAM (random access memory) or ROM (read only memory). For network communications (e.g., intra-network communications, inter-network communications including Internet connections), the servers can include one or more network interface cards (NICs) (including wireless NICs (WNICs)) that can be used to transport data to and from the computers. These NICs can allow the one or more servers 82 to connect with one another, databases 84, or other networking devices, including routers, modems, and/or switches. In one particular embodiment, the NICs (including WNICs) of servers 82 may allow SRWC connections to be established and/or may include Ethernet (IEEE 802.3) ports to which Ethernet cables may be connected to that can provide for a data connection between two or more devices. Remote facility 80 can include a number of routers, modems, switches, or other network devices that can be used to provide networking capabilities, such as connecting with land network 76 and/or cellular carrier system 70.

Databases 84 can be stored on a plurality of memory, such as a powered temporary memory or any suitable non-transitory computer-readable medium; these include different types of RAM (random access memory), ROM (read only memory), and magnetic or optical disc drives that stores some or all of the software needed to carry out the various external device functions discussed herein. One or more databases at the remote facility can store account information such as vehicle services subscriber authentication information, vehicle identifiers, vehicle transactional information, geographical coordinates of the vehicle, and other vehicle information. Also, a vehicle information database can be included that stores information pertaining to one or more vehicles. Additionally, in one embodiment, databases 84 can include geographical map information including geographical roadway map data that digitally represents geographical areas including roadways on the surface of earth. Servers 82 can be used to provide this geographical roadway map data to a plurality of vehicles, including vehicle 12, so that the vehicles can correlate geographical coordinates (as obtained via GNSS receiver 22) with roadways and other features (e.g., points of interest, addresses, speed limits). In a particular embodiment, the vehicle 12 can send a geographical map request message that includes a geographical location or region of the vehicle and, in response to this message, the server 82 can query database 84 to obtain geographical map information corresponding to the geographical location or region of the vehicle. The server 82 can then send this information to the vehicle 12 (and various other vehicles) via land network 76 and/or cellular carrier system 70.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 20 are shown generally in FIG. 1 and includes a global navigation satellite system (GNSS) receiver 22, body control module or unit (BCM) 24, other vehicle system modules (VSMs) 26, a wireless communications device 30, wheel speed sensors 40, steering wheel angle sensor 42, yaw rate sensor 44, throttle position sensor 46, cameras 48, and vehicle-user interfaces 50-58. Some or all of the different vehicle electronics may be connected for communication with each other via one or more communication busses, such as bus 28. Communications bus 28 provides the vehicle electronics with network connections using one or more network protocols. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

The vehicle 12 can include numerous vehicle system modules (VSMs) as part of vehicle electronics 20, such as the GNSS receiver 22, BCM 24, wireless communications device 30, wheel speed sensors 40, steering wheel angle sensor 42, yaw rate sensor 44, throttle position sensor 46, cameras 48, and vehicle-user interfaces 52-58, as will be described in detail below. The vehicle 12 can also include other VSMs 26 in the form of electronic hardware components that are located throughout the vehicle and, which may receive input from one or more sensors and use the sensed input to perform diagnostic, monitoring, control, reporting, and/or other functions. Each of the VSMs 26 is preferably connected by communications bus 28 to the other VSMs, as well as to the wireless communications device 30, and can be programmed to run vehicle system and subsystem diagnostic tests. One or more VSMs 26 may periodically or occasionally have their software or firmware updated and, in some embodiments, such vehicle updates may be over the air (OTA) updates that are received from a computer 78 or remote facility 80 via land network 76 and communications device 30. As is appreciated by those skilled in the art, the above-mentioned VSMs are only examples of some of the modules that may be used in vehicle 12, as numerous others are also possible.

Global navigation satellite system (GNSS) receiver 22 receives radio signals from a constellation of GNSS satellites. GNSS receiver 22 can be configured to comply with and/or operate according to particular regulations or laws of a given geopolitical region (e.g., country). The GNSS receiver 22 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems.

GNSS receiver 22 may be used to provide navigation and other position-related services to the vehicle operator. Navigation information can be presented on the display 58 (or other display within the vehicle) or can be presented verbally such as is done when supplying turn-by-turn navigation. The navigation services can be provided using a dedicated in-vehicle navigation module (which can be part of GNSS receiver 22 and/or incorporated as a part of wireless communications device 30 or other VSM), or some or all navigation services can be done via the vehicle communications device (or other telematics-enabled device) installed in the vehicle, wherein the position information is sent to a remote location for purposes of providing the vehicle with navigation maps, map annotations (points of interest, restaurants, etc.), route calculations, and the like. The position information can be supplied to remote facility 80 or other remote computer system, such as computer 78, for other purposes, such as fleet management and/or for use in a car sharing service. Also, new or updated map data, such as that geographical roadway map information stored on databases 84, can be downloaded to the GNSS receiver 22 from the remote facility 80 via vehicle communications device 30.

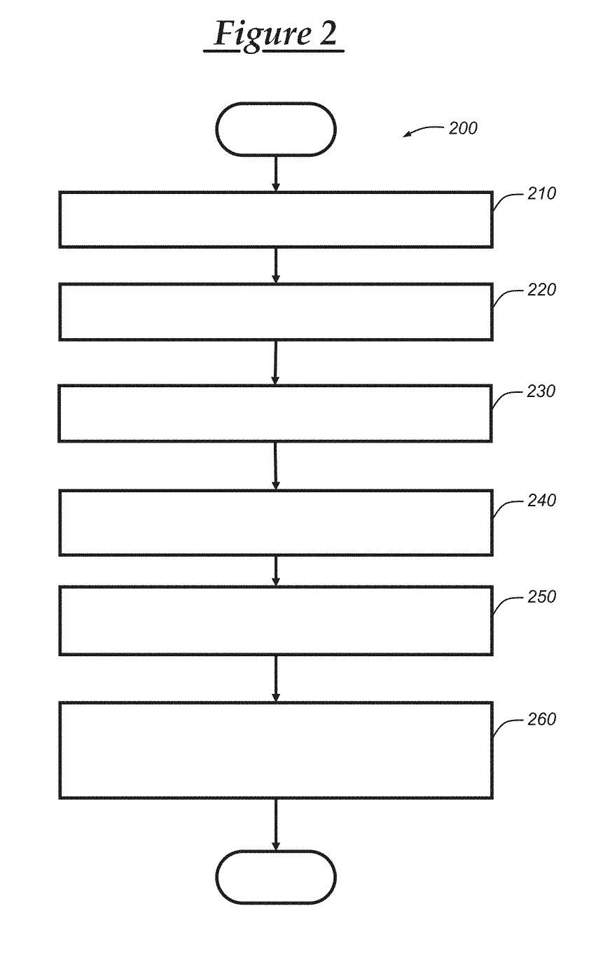

In one embodiment, the GNSS receiver 22 may be a GPS receiver, which may receive GPS signals from a constellation of GPS satellites 96. And, in another embodiment, GNSS receiver 22 can be a BDS receiver that receives a plurality of GNSS (or BDS) signals from a constellation of GNSS (or BDS) satellites 60. In either implementation, GNSS receiver 22 includes at least one processor and memory, including a non-transitory computer readable memory storing instructions (software) that are accessible by the processor for carrying out the processing performed by the receiver 22. Some of that processing may include making adjustments to the geographic coordinates received/determined by the receiver 22 before providing them to the remainder of the vehicle for use in navigation. This may be done, for example, to improve accuracy for vehicles operated in certain geopolitical regions that may require GNSS signals to be adjusted so as to reduce GNSS accuracy thereby increasing national security. For some countries, this intentional inaccuracy is introduced using a proprietary geo-shifting application, which results in adjusting the derived geographical coordinates by a random number. This “geo-shifting” adjustment results in geographical coordinates with reduced accuracy, which can be troublesome for autonomous or semi-autonomous vehicle operation, as well as numerous other applications that require or are based at least partly on the geographical coordinates. As used herein, “geo-shifting” refers to GNSS coordinate processing that results in reducing the accuracy of the geographical coordinates. And, as used herein, “geo-shifted coordinates” refers to those geographical coordinates that have been geo-shifted. The reduced accuracy of the geographical coordinates can be mitigated by the method 200 (FIG. 2) and various other embodiments of the method discussed herein, as will be made apparent from the discussion below.

Body control module (BCM) 24 is shown in the exemplary embodiment of FIG. 1 as being electrically coupled to communication bus 28. In some embodiments, the BCM 24 may be integrated with or part of a center stack module (CSM) and/or integrated with wireless communications device 30. Or, the BCM may be a separate device that is connected to other VSMs via bus 28. BCM 24 can include a processor and/or memory, which can be similar to processor 36 and memory 38 of wireless communications device 30, as discussed below. BCM 24 may communicate with wireless device 30 and/or one or more vehicle system modules, such as an engine control unit (ECU) (not shown), wheel speed sensor 40, steering wheel angle sensor 42, yaw rate sensor 44, throttle position sensor 46, cameras 48, audio system 54, or other VSMs 26. BCM 24 may include a processor and memory accessible by the processor. Suitable memory may include non-transitory computer-readable memory that includes various forms of non-volatile RAM and ROM. Software stored in the memory and executable by the processor enables the BCM to direct one or more vehicle operations including, for example, controlling central locking, air conditioning, power mirrors, controlling the vehicle primary mover (e.g., engine, primary propulsion system), and/or controlling various other vehicle modules. For example, the BCM 24 can send signals to other VSMs, such as a request for sensor information. And, the BCM 24 may receive data from VSMs, including wheel speed readings or sensor data from wheel speed sensor 40, steering wheel angle readings or sensor data from steering wheel angle sensor 42, yaw rate readings or sensor data from yaw rate sensor 44, throttle position readings or sensor data from throttle position sensor 46, and camera data from cameras 48.

Additionally, BCM 24 may provide vehicle state information corresponding to the vehicle state or of certain vehicle components or systems. For example, the BCM may provide the device 30 with information indicating whether the vehicle's ignition is turned on, the gear the vehicle is presently in (i.e. gear state), and/or other information regarding the vehicle. The BCM 24 can obtain information from one or more other vehicle modules to obtain this information.

Wheel speed sensors 40 are sensors that are each coupled to a wheel and that can determine a rotational speed of the respective wheel. The rotational speeds from various wheel speed sensors can then be used to obtain a linear or transverse vehicle speed. Additionally, in some embodiments, the wheel speed sensors 40 can be used to determine acceleration of the vehicle. The wheel speed sensors 40 can include a tachometer that is coupled to a vehicle wheel and/or other rotating member. In some embodiments, wheel speed sensors 40 can be referred to as vehicle speed sensors (VSS) and can be a part of an anti-lock braking (ABS) system of the vehicle 12 and/or an electronic stability control program. As discussed more below, the electronic stability control program can be embodied in a computer application or program that can be stored on a non-transitory, computer-readable memory (such as that which is included in BCM 24 or memory 38). The electronic stability control program can be executed using a processor of BCM 24 (or processor 36 of the wireless communications device 30) and can use various sensor readings or data from a variety of vehicle sensors including wheel speed readings or sensor data from wheel speed sensor 40, steering wheel angle readings or sensor data from steering wheel angle sensor 42, yaw rate readings or sensor data from yaw rate sensor 44, throttle position readings or sensor data from throttle position sensor 46, and camera data from cameras 48.

Steering wheel angle sensor (or steering angle sensor) 42 is a sensor that is coupled to a steering wheel of vehicle 12 or a component of the steering wheel, including any of those that are a part of the steering column. The steering wheel angle sensor 42 can detect the angle that a steering wheel is rotated, which can correspond to the angle of one or more vehicle wheels with respect to a longitudinal axis of vehicle 12 that runs from the back to the front. Sensor data and/or readings from the steering wheel angle sensor 42 can be used in the electronic stability control program that can be executed on a processor of BCM 24 or processor 36.

Yaw rate sensor 44 obtains vehicle angular velocity information with respect to a vertical axis of the vehicle. The yaw rate sensor 44 can include gyroscopic mechanisms that can determine the yaw rate and/or the slip angle. Various types of yaw rate sensors can be used, including micromechanical yaw rate sensors and piezoelectric yaw rate sensors. The yaw rate sensor 42 can obtain various sensor data or readings (such as yaw rate readings and/or slip angle readings) and, then, this information can be communicated to BCM 24 (or other VSM) and used as a part of the electronic stability control program.

Throttle position sensor (TPS) 46 can be used to determine a position of a throttle device of vehicle 12. For example, the throttle position sensor 46 can be coupled to an electronic throttle body or system that is controlled by an actuator (such as a gas pedal) via a throttle actuation controller. TPS 46 can measure throttle position in a variety of ways, including through using a pin that rotates according to the throttle position (e.g., the output of the throttle actuation controller) and that reads a voltage through the pin. The voltage through the pin can vary due to the pin's position, which varies the amount of resistance of the circuit and, thus, the voltage. This voltage data (or other data derived therefrom) can be sent to BCM 24, which can use such readings as a part of the electronic stability control program, as well as various other programs or applications.

Cameras 48 can be used to capture photographs, videos, and/or other information pertaining to light. Cameras 48 can be an electronic digital camera that is powered through use of a vehicle battery. Cameras 48 may include a memory device and a processing device to store and/or process data that it captures or otherwise obtains. The data obtained by cameras 48 may be sent to another vehicle system module (VSM) such as wireless communications device 30 and/or BCM 24. Cameras 48 may be of any suitable camera type (e.g., charge coupled device (CCD), complementary metal oxide semiconductor (CMOS), etc.) and may have any suitable lens known in the art. Some non-limiting examples of potential embodiments or features that may be used with cameras 48 include: infrared LEDs for night vision; wide angle or fish eye lenses; surface mount, flush mount, license mount, or side mount cameras; stereoscopic arrangements with multiple cameras; cameras integrated into tail lights, brake lights, or other components at the rear end of the vehicle; and wired or wireless cameras, to cite a few possibilities.

Cameras 48 can be installed and/or mounted on vehicle 12 and may be configured to face an area to the side of vehicle 12 such as an area that includes the ground near or around vehicle tires. In such an embodiment, camera data can be obtained through using cameras 48 to capture images and, then, image processing techniques can be used to recognize or identify lane markers and/or other roadway features. According to a particular embodiment, a first camera can be mounted on the left side of the vehicle 12 and a second camera can be mounted on the right side of the vehicle 12. Additionally, or alternatively, a third camera can be mounted on the front of the vehicle (or at least facing the area in front of the vehicle) and a fourth camera can be mounted on the back of the vehicle (or at least facing the area behind the vehicle). For example, the first and second camera can be mounted on a side mirror and can be arranged so as to capture an area of the roadway. The third camera can be mounted on the rearview mirror and facing an area in front of the vehicle and/or can be mounted on another portion of the front of the vehicle, including areas on the outside of the vehicle. The fourth camera can be mounted on a rear exterior portion of vehicle 12 and, in some embodiments, the fourth camera can be used as a backup camera (or reversing camera) that is already included as a part of many consumer vehicles, including cars and trucks, or that may be required by one or more laws or regulations, including those regulations of the National Highway Traffic Safety Administration (NHTSA) that requires certain vehicles to include a backup camera. In one embodiment, the a camera 48 may be mounted on or embedded within a rear bumper of vehicle 12, a trunk or other rear door of vehicle 12, a tailgate (including those included in pickup trucks) of vehicle 12, a spoiler of vehicle 12, and/or any other location on vehicle 12 that is suitable for mounting or embedding camera 48 such that the field of view includes an area behind vehicle 12.

In many embodiments, multiple cameras 48 can be used, each of which can be mounted and/or installed on vehicle 12; however, in some embodiments, a single camera can be used. In one particular embodiment, multiple cameras can be positioned on the exterior of the vehicle and facing in the rearward direction of the vehicle. Two or more cameras may be configured in a stereoscopic orientation such that video data is captured from multiple perspectives of an area and, when combined and processed according to a three-dimensional rendering algorithm, a three-dimensional reconstruction of the captured area may be rendered. This rendering may then be displayed on a visual display, such as visual display 58 or other display. A stereoscopic orientation refers to an orientation of multiple cameras such that their fields of view overlap thereby allowing multiple perspectives of the area to which their respective fields of view overlap.

Wireless communications device 30 is capable of communicating data via short-range wireless communications (SRWC) and/or via cellular network communications through use of a cellular chipset 34, as depicted in the illustrated embodiment. In the illustrated embodiment, wireless communications device 30 includes an SRWC circuit 32, a cellular chipset 34, a processor 36, memory 38, and antennas 33 and 35. In one embodiment, wireless communications device 30 may be a standalone module or, in other embodiments, device 30 may be incorporated or included as a part of one or more other vehicle system modules, such as a center stack module (CSM), body control module (BCM) 24, an infotainment module, a head unit, and/or a gateway module. In some embodiments, the device 30 can be implemented as an OEM-installed (embedded) or aftermarket device that is installed in the vehicle. In many embodiments, the wireless communications device 30 is a telematics unit (or telematic control unit) that is capable of carrying out cellular communications using one or more cellular carrier systems 70. The telematics unit can be integrated with the GNSS receiver 22 so that, for example, the GNSS receiver 22 and the wireless communications device (or telematics unit) 30 are directly connected to one another as opposed to being connected via communications bus 28.

Additionally, the wireless communications device 30 can be incorporated with or at least connected to a navigation system that includes geographical map information including geographical roadway map information. The navigation system can be communicatively coupled to the GNSS receiver 22 (either directly or via communications bus 28) and can include an on-board geographical map database that stores such geographical map information. This geographical map information can be provisioned in the vehicle and/or downloaded via a remote connection to a geographical map database/server, such as computer 78 and/or remote facility 80 (including servers 82 and databases 84). The on-board geographical map database can store geographical map information corresponding to a location or region of the vehicle so as to not include a large amount of data, much of which will most likely never be used. Moreover, as the vehicle enters different locations or regions, the vehicle can inform the vehicle backend services facility 80 of the vehicle's location (e.g., obtained via use of GNSS receiver 22) and, in response to receiving the vehicle's new location, the servers 82 can query databases 84 for the corresponding geographical map information, which can then be sent to the vehicle 12.

In some embodiments, wireless communications device 30 can be configured to communicate wirelessly according to one or more short-range wireless communications (SRWC) such as any of the Wi-Fi™, WiMAX™, Wi-Fi Direct™, other IEEE 802.11 protocols, ZigBee™, Bluetooth™, Bluetooth™ Low Energy (BLE), or near field communication (NFC). As used herein, Bluetooth™ refers to any of the Bluetooth™ technologies, such as Bluetooth Low Energy™ (BLE), Bluetooth™ 4.1, Bluetooth™ 4.2, Bluetooth™ 5.0, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. The short-range wireless communication (SRWC) circuit 32 enables the wireless communications device 30 to transmit and receive SRWC signals, such as BLE signals. The SRWC circuit may allow the device 30 to connect to another SRWC device. Additionally, in some embodiments, the wireless communications device may contain a cellular chipset 34 thereby allowing the device to communicate via one or more cellular protocols, such as those used by cellular carrier system 70.

Wireless communications device 30 may enable vehicle 12 to be in communication with one or more remote networks (e.g., one or more networks at remote facility 80 or computers 78) via packet-switched data communication. This packet-switched data communication may be carried out through use of a non-vehicle wireless access point that is connected to a land network via a router or modem. When used for packet-switched data communication such as TCP/IP, the communications device 30 can be configured with a static IP address or can be set up to automatically receive an assigned IP address from another device on the network such as a router or from a network address server.

Packet-switched data communications may also be carried out via use of a cellular network that may be accessible by the device 30. Communications device 30 may, via cellular chipset 34, communicate data over wireless carrier system 70. In such an embodiment, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

Processor 36 can be any type of device capable of processing electronic instructions including microprocessors, microcontrollers, host processors, controllers, vehicle communication processors, and application specific integrated circuits (ASICs). It can be a dedicated processor used only for communications device 30 or can be shared with other vehicle systems. Processor 36 executes various types of digitally-stored instructions, such as software or firmware programs stored in memory 38, which enable the device 30 to provide a wide variety of services. For instance, processor 36 can execute programs or process data to carry out at least a part of the method discussed herein. Memory 38 may be a temporary powered memory or any non-transitory computer-readable medium; these include different types of RAM (random access memory) and ROM (read only memory) that stores some or all of the software needed to carry out the various external device functions discussed herein. Similar components to those previously described (processor 36 and/or memory 38, as well as SRWC circuit 32 and cellular chipset 34) can be included in body control module 24 and/or various other VSMs that typically include such processing/storing capabilities.

Vehicle electronics 20 also includes a number of vehicle user interfaces that provide vehicle occupants with a means of providing and/or receiving information, including pushbutton(s) 52, audio system 54, microphone 56, and visual display 58. As used herein, the term “vehicle-user interface” broadly includes any suitable form of electronic device, including both hardware and software components, which is located on the vehicle and enables a vehicle user to communicate with or through a component of the vehicle. The pushbutton(s) 52 allow manual user input into the communications device 30 to provide other data, response, or control input. Audio system 54 provides audio output to a vehicle occupant and can be a dedicated, stand-alone system or part of the primary vehicle audio system. According to the particular embodiment shown here, audio system 54 is operatively coupled to both vehicle bus 28 and an entertainment bus (not shown) and can provide AM, FM and satellite radio, CD, DVD and other multimedia functionality. This functionality can be provided in conjunction with or independent of an infotainment module. Microphone 56 provides audio input to the wireless communications device 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display or touch screen 58 is preferably a graphics display and can be used to provide a multitude of input and output functions. Display 58 can be a touch screen on the instrument panel, a heads-up display reflected off of the windshield, or a projector that can project graphics for viewing by a vehicle occupant. Any one or more of these vehicle-user interfaces that can receive input from a user can be used to receive a driver override request, which is a request to cease operating the one or more VSMs as a part of the immersive media experience. Various other vehicle user interfaces can also be utilized, as the interfaces of FIG. 1 are only an example of one particular implementation.

With reference to FIG. 2, there is shown a method 200 of determining a geographical location of a vehicle. Method 200 can be carried out by vehicle electronics 20 and, in some embodiments, can be carried out by wireless communications device 30 and/or BCM 24. Generally, method 200 can include the steps of receiving geographical roadway map data, determining geographical coordinates of a vehicle using a plurality of global navigational satellite (GNSS) signals, obtaining vehicle lateral displacement and/or vehicle dynamics information, and adjusting the geographical coordinates based on the obtained information. However, various other embodiments exist, as will be apparent from the discussion below in light of the discussion of system 10 provided above.

In one embodiment, the method 200 or parts thereof can be implemented in a computer program (or “application”) embodied in a computer readable medium and including instructions usable by one or more processors of one or more computers of one or more systems. The computer program may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program can be executed on one computer or on multiple computers in communication with one another.

The program(s) can be embodied on computer readable media (such as memory 38 and/or memory in BCM 24), which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

Method 200 begins with step 210, wherein geographical roadway map data is received. The geographical roadway map data includes data representing geographical regions including data representing roadways among the geographical regions. The geographical roadway map data can include various additional information, such as roadway dimensions, roadway attributes (e.g., speed limit, permitted direction of travel, lane information, traffic signal information), roadway conditions (e.g., present or estimated traffic conditions, predicted and/or observed weather conditions among the roadway), and various other information.

In many embodiments, the geographical roadway map data can be received via land network 76 and/or cellular carrier system 70. The geographical roadway map data can be sent in one or more packets and/or can be received at various times. In one embodiment, geographical roadway map data can be downloaded that corresponds to an area in which vehicle 12 is intended or anticipated as being operated, such as a metropolitan area of a major city in which the vehicle is purchased and/or delivered. The geographical roadway map data can also be updated and/or downloaded periodically and, in some embodiments, can be downloaded upon the vehicle entering or nearing a geographical region in which the vehicle does not presently hold geographical roadway map data. In this way, geographical roadway map data can be downloaded based on vehicle location thereby saving downloading costs and/or transmission costs. As mentioned, upon the vehicle entering or nearing a new geographical region (i.e., a geographical region in which the vehicle does not hold geographical roadway map data).

In one embodiment, the geographical roadway map data can be stored at a database 84 of remote facility 80 and, upon receiving a geographical roadway map data request from the vehicle 12, the geographical roadway map data can be sent to the vehicle 12 and can be based on vehicle location information included in the geographical roadway map data request. In some embodiments, the geographical roadway map data can be stored in a database operated and/or owned by an original equipment manufacturer (OEM) of the vehicle and/or can be stored in a database operated and/or owned by a third party geographical map data provider. Once the geographical roadway map data is received, the method 200 continues to step 220.

In step 220, geographical coordinates of the vehicle are determined from a plurality of global navigational satellite (GNSS) signals. The geographical coordinates can include a longitudinal and a latitudinal coordinate pair that represents the position of the vehicle 12. In some embodiments, the geographical coordinates can include an elevation with respect to sea level (or other reference point upon the Earth). The vehicle 12 includes a GNSS receiver 22 that receives a plurality of GNSS signals from a constellation of GNSS satellites 60. The GNSS receiver 22 can include a dedicated GNSS circuit including processing capabilities particularly designed to determine or obtain geographical coordinates and/or other various information, such as time and velocity, from the received GNSS signals. In other embodiments, the GNSS receiver 22 can include hardware components for receiving and/or performing pre-processing of the GNSS signals and, additionally, the geographical coordinates can be determined through executing a software program using processor 36 and/or another processing device of the vehicle 12. As mentioned above, the received GNSS signals used by the GNSS receiver 20 may depend on the geopolitical region in which the vehicle is located; for example, when the vehicle is located in China, the GNSS signals used may be BeiDou Navigation Satellite System (BDS) signals and the GNSS satellites 60 can be BDS satellites and when the vehicle is located in the United States, the GNSS signals can be global positioning system (GPS) signals and the GNSS satellites 60 can be GPS satellites. The GNSS signals can be stored and/or sent to another device or location via cellular carrier system 70 and/or land network 76. The method 200 continues to step 230.

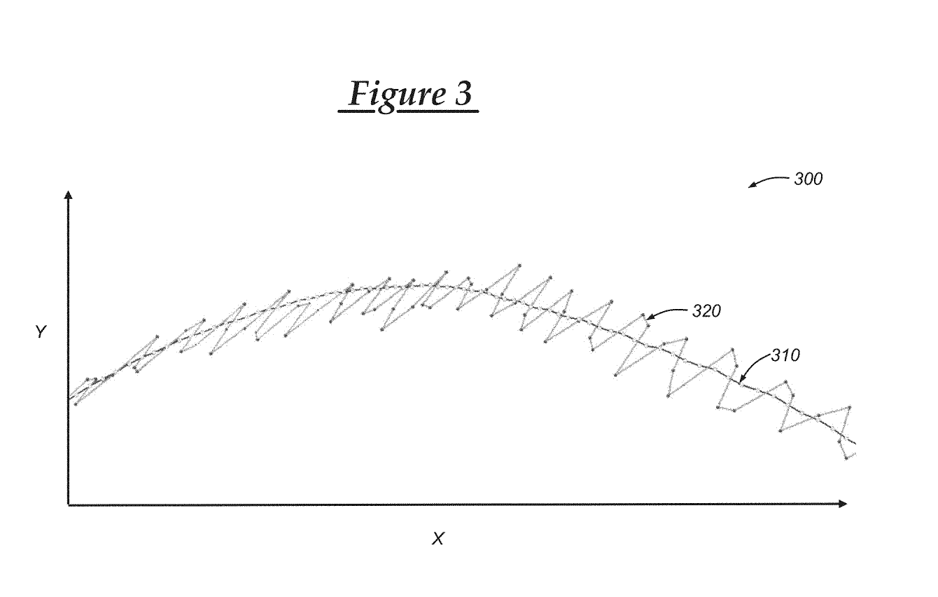

In step 230, geo-shifting is applied to the geographical coordinates. The geo-shifting can be carried out by the GNSS receiver (or other VSM of the vehicle 12) and, in some embodiments, can be imposed by local laws or regulations of the geopolitical region in which the vehicle is located. For example, as mentioned above, in some countries, “geo-shifting” of geographical coordinates are required by regulation or law. The governments of these countries may provide a proprietary geo-shifting application that is required to be installed on all commercial GNSS receivers (although exceptions may exist). This geo-shifting application causes geographical coordinates determined by the GNSS receiver to be adjusted according to randomly generated values so as to reduce the accuracy of the geographical coordinates thereby improving national security. For example, with reference to FIG. 3, there is shown a plot of the vehicle's location 300, including the geographical coordinates 310 and the geo-shifted geographical coordinates 320. The geographical coordinates 310 can be those coordinates as determined in step 220 and the geo-shifted geographical coordinates can be the geographical coordinates as shifted by the geo-shifting techniques. And, in some embodiments, geo-shifting must be performed before the geographical coordinates are sent out to other devices (devices other than the GNSS receiver 22) or modules of the vehicle.

In other embodiments, geo-shifting may not be applied to the geographical coordinates; nonetheless, the method 200 can still be used to obtain geographical coordinates with improved accuracy and/or to corroborate the determined geographical coordinates. However, at least in some embodiments, to overcome the negative effects of geo-shifting, vehicle self-localization techniques can be used to improve the vehicle's location awareness thereby improving autonomous and semi-autonomous vehicle operations, as well as other vehicle functionality that uses GNSS coordinates. These techniques are discussed below in steps 240 to 260. The method 200 continues to step 240.

In step 240, vehicle lateral displacement information is obtained. As used herein, vehicle lateral displacement information is information or data representing a position of the vehicle on the roadway in which the vehicle is located and/or traveling. The vehicle lateral displacement can be determined through using one or more vehicle system modules (VSMs), such as cameras 48. For example, vehicle lateral displacement can be determined through capturing images of an area of the roadway using cameras 48, such as an area to the side of the vehicle 12, processing the captured images using image processing techniques (e.g., object recognition techniques), and, then, obtaining a distance between the vehicle and the roadway on which the vehicle is traveling.

In one embodiment, a first camera can be positioned on a left side of the vehicle 12 and facing an area to the left of the vehicle. The first camera 48 can be positioned on the underside of a side mirror located on the left side of the vehicle 12 and/or in a position so as to capture an area to the left of the vehicle. For example, when the vehicle 12 is traveling along a roadway, the first camera can capture an area, which may include lane markers. The vehicle 12 can use processor 36 (or other processing device) to identify lane markers. Thereafter, the vehicle 12 can use predetermined or predefined information relating to the configuration and/or positioning of the first camera in conjunction with the identified lane markers to determine a vehicle lateral displacement. The vehicle lateral displacement can be represented as a distance in meters or feet (or other linear distance measurement). In some embodiments, the vehicle 12 can use a plurality of cameras 48 to determine the vehicle lateral displacement and, in at least one embodiment, the vehicle 12 can determine a first vehicle lateral displacement and, thereafter, the vehicle can use captured images (or data) from a second camera (and/or third camera, fourth camera, etc.) to corroborate the calculated vehicle lateral displacement. Various implementations of calculating the vehicle lateral displacement can be used, including pixel counting methods (e.g., where pixels are counted between a reference point and an identified roadway feature, such as a lane marker or a road edge). The method 200 continues to step 250.

In step 250, vehicle dynamics information is obtained. As used herein, vehicle dynamics information refers to information concerning the vehicle's location and/or motion, including information that can be used to derive or estimate the vehicle's location and/or motion, such as vehicle kinematics information. For example, vehicle dynamics information includes wheel speeds of one or more wheels (or tires, axles, etc.) of the vehicle 12 as determined by wheel speed sensors 40, steering wheel angle of a steering wheel of the vehicle 12 (or other information that can be used to derive a vehicle wheel direction or heading) as determined by steering wheel angle sensor 42, yaw rate of the vehicle 12 as determined by yaw rate sensor 44, and throttle position or vehicle acceleration as determined by throttle position sensor 46. Various other vehicle dynamics information may be used in addition to or in lieu of these sensor inputs, as will be apparent to those skilled in the art.

In one embodiment, a vehicle speed ν can be determined based on information sensed by wheel speed sensors 40. The vehicle speed ν can be calculated by information received from one or more wheel speed sensors 40 that are included as a part of vehicle 12. Additionally, a yaw rate information and steering wheel angle can be used to calculate the yaw rate of the vehicle 12 as well as the heading of the vehicle. This information can then be used in conjunction with wheel speed information to calculate the vehicle speed ν. A vehicle direction or heading can be calculated or otherwise determined and represented as an angle from north (i.e., north is 0°), which can be denoted as a. As mentioned above, other vehicle dynamics information can be obtained and/or determined. Information can be communicated from sensors 40-46 via communications bus 28 and to BCM 24 and/or wireless communications device 30. BCM 24 and/or wireless communications device 30 can be used to receive information from sensors 40-48 and, thereafter, to process the information to determine vehicle speed ν and heading α, as well as other vehicle dynamics information. The method 200 continues to step 260.

In step 260, the geographical coordinates are adjusted based on the vehicle lateral displacement (step 240) and/or the vehicle dynamics information (step 250). The vehicle lateral displacement can be used in conjunction with the geographical map data to adjust the geographical coordinates so that the vehicle is aligned on the roadway as indicated by the geographical roadway map data and the vehicle lateral displacement. For example, the vehicle can use the geo-shifted coordinates (including a plurality of geo-shifted coordinate pairs) to determine a roadway on which the vehicle is traveling. Thereafter, the vehicle can use vehicle directional information and/or the vehicle lateral displacement to adjust the geographical coordinates to reflect a more accurate position on the geographical roadway map data. In one embodiment, the vehicle direction can be used to determine which side of the roadway the vehicle is travelling on and, additionally, the vehicle lateral displacement and other observed information can be used to determine which lane the vehicle is in, as well as a lateral distance between the vehicle and one or more roadway features including a roadway edge and/or lane markers. According to at least one embodiment, the vehicle dynamics information can be used to adjust the fore and aft position of the geographical coordinates (with respect to vehicle heading, the fore and aft is the area behind and in front of the vehicle). And, in some embodiments, the vehicle lateral displacement can be used to adjust the lateral position of the geographical coordinates (with respect to vehicle heading, the lateral position is the area to the sides of the vehicle).

In one embodiment, the vehicle can use an extended Kalman filter (EKF) that can determine a space vector Xₖ₊ₙ of the vehicle, which includes an x-position (e.g., x-coordinate) x of the vehicle, a y-position (e.g., y-coordinate) y of the vehicle, a heading angle α of the vehicle, a vehicle speed ν of the vehicle, and a change of heading angle α_{Δ}. As a starting point (xₖ), the vector can use values as determined by the GNSS receiver 22 and as adjusted in light of the vehicle lateral displacement and/or the vehicle dynamics information. The input vector can be represented as:

$${x}_{k} = [ \begin{matrix}x \\ y \\ α \\ v \\ {α}_{Δ}\end{matrix} ] \qquad ( Equation 1 )$$

where xₖ represents the state space vector of the vehicle, as defined by the variables x, y, α, ν, and α_{Δ}. Equation 1 represents one state space vector, as many others can be used.

To solve for the next state space vector Xₖ₊₁ of the vehicle as adjusted by the vehicle lateral displacement and/or the vehicle dynamics information, the following equation can be used:

$${x}_{k + 1} = g ( {x}_{k} , u ) = [ \begin{matrix}x + \frac{v}{{α}_{Δ}} ( - sin ( α ) + sin ( T {α}_{Δ} + α ) ) \\ y + \frac{v}{{α}_{Δ}} ( cos ( α ) - cos ( T {α}_{Δ} + α ) ) \\ T {α}_{Δ} + α \\ v \\ {α}_{Δ}\end{matrix} ] \qquad ( Equation 2 )$$

where T is the time between the state space vector of the vehicle at Xₖ and Xₖ₊₁. This adaptive extended Kalman filter can be used for calculating a state space vector of the vehicle, which results in an x-coordinate and a y-coordinate with improved accuracy due to the incorporation of the vehicle lateral displacement and vehicle dynamics information.

In some embodiments, the error covariance Pₖ₊₁ can be predicted during times when the GNSS coordinates are not able to be accurately determined from GNSS signals, such as during times when the vehicle is inside a tunnel or in another area where GNSS signals may not be received. This covariance error Pₖ₊₁ can be calculated using measurement noise covariance R, which can be updated based on the vehicle's location, the predicted or observed GNSS signal strength or reception (e.g., areas having a higher standard deviation than when the GNSS receiver is experiencing normal reception), and/or various other information including vehicle speed and/or heading. Given the knowledge of the current vehicle location relative to the tunnels or other GNSS signal challenged areas, the measurement noise covariance R can be adjusted to better reflect the actual measurement standard deviation and, hence, the EKF can be used in a way so as to adjust the relative weights (or values) of the state estimates and measurements (e.g., the inputs of the state space vector). The covariance error Pₖ₊₁ can then be used to update the state space vector of the vehicle. For example, the projected error covariance Pₖ₊₁ can be calculated using the following equation:

Pₖ₊₁=J_{A}PₖJ_{A}^{T}+Q (Equation 3)

where Pₖ₊₁ is error covariance at time loop k+1, where J_{A} is the Jacobian matrix of the dynamic matrix with respect to the state vector xₖ, where Pₖ is error covariance of the previous iteration (or an initial value) at time loop k, where J_{A}^{T} is the transpose matrix of J_{A}, and where Q is the covariance matrix. In many embodiments, the values of the variables of Equation 3 are represented in the form of a matrix.

After the error covariance is projected, this error covariance Xₖ₊₁ (now xₖ) can be used to compute or calculate the Kalman gain Kₖ, which can be done, for example, using the following equation:

Kₖ=PₖJ_{H}^{T}(J_{H}PₖJ_{H}^{T}+R)⁻¹ (Equation 4)

where J_{H}^{T} is the transpose matrix of J_{H}, J_{H} is the Jacobian matrix of the measurement function, and R is the measurement noise covariance. As mentioned above, the measurement noise covariance R can be tuned and/or adjusted based on the location of the vehicle, as well as GNSS conditions including GNSS reception.
Once the Kalman gain Kₖ is calculated, the space vector Xₖ can be updated based on the Kalman gain Kₖ. For example, the following equation can be used to update the space vector Xₖ:

xₖ=xₖ+Kₖ(zₖ−h(xₖ)) (Equation 5)

where zₖ is the measurement matrix and h(xₖ) is the observation model that maps the true state space into the observed space. Additionally, the error covariance can be updated using the following equation:

Pₖ(I−KₖJ_{H})Pₖ (Equation 6)

Those skilled in the art will appreciate that various derivations of the above Equations 1 through 6 exist and may be applied to update or adjust the space vectors xₖ₊ₙ. Additionally, many of the variables represent a matrix, as those skilled in the art may appreciate. After the space vector is calculated and, then, updated using the projected or estimated error covariance, the method 200 ends. The steps 210-260 of the method 200 can be carried out again for a plurality of subsequent iterations. In some embodiments, certain steps can be skipped in future iterations where the information known to the vehicle is already sufficient for carrying out the subsequent iterations. For example, step 210 can be skipped in subsequent iterations where the vehicle 12 already includes the geographical roadway map data of the area surrounding the vehicle 12. And, in some embodiments, the vehicle lateral displacement and/or the vehicle dynamics information can be used for one or more iterations of step 260 (such as for use in the adjusted EKF as discussed above).

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering any one or more of the following: “A”; “B”; “C”; “A and B”; “A and C”; “B and C”; and “A, B, and C.”

1. A method of determining a geographical location of a vehicle, the method comprising:
obtaining geographical coordinates of the vehicle;
determining a lateral ground displacement within a roadway on which the vehicle is traveling;
receiving geographical map data that includes one or more roadways including the roadway on which the vehicle is traveling; and
adjusting the geographical coordinates of the vehicle based on the lateral ground displacement and the geographical map data.

2. The method of claim 1, wherein the obtaining step includes receiving a plurality of global navigational satellite (GNSS) signals from a plurality of GNSS satellites and determining a geographical location based on the received GNSS signals.

3. The method of claim 1, wherein the determining step includes:
obtaining images of the roadway on which the vehicle is traveling using at least one camera or light sensor that is installed on the vehicle as part of vehicle electronics; and
processing the obtained images to determine the lateral ground displacement of the vehicle within the roadway on which the vehicle is traveling.

4. The method of claim 3, wherein the vehicle electronics includes a plurality of cameras installed on the vehicle and that are used to obtain the images of the roadway on which the vehicle is traveling.

5. The method of claim 1, further comprising the step of applying geo-shifting to the geographical coordinates before the adjusting step.

6. The method of claim 5, wherein the geo-shifting is imposed by a jurisdiction in which the vehicle is located.

7. The method of claim 1, further comprising the step of obtaining vehicle dynamics information including vehicle speed information and vehicle heading information, wherein the adjusting step is based on the vehicle dynamics information.

8. The method of claim 7, wherein the vehicle dynamics information further includes vehicle acceleration information and wherein the vehicle speed information is based on a vehicle wheel speed and/or a vehicle transverse speed.

9. The method of claim 8, wherein the adjusting step includes using an extended Kalman filter to calculate new geographical coordinates based on the geographical coordinates, the vehicle dynamics information, and the vehicle lateral displacement.

10. The method of claim 1, further comprising the step of obtaining geographical roadway map information of a region surrounding the vehicle.

11. A method of determining a geographical location of a vehicle, the method comprising:
determining geographical coordinates of the vehicle using a global navigation satellite system (GNSS) receiver included in the vehicle, wherein the geographical coordinates are determined by receiving a plurality of GNSS signals from a constellation of GNSS satellites;
shifting the geographical coordinates using geo-shifting techniques using the GNSS receiver;
determining a lateral ground displacement within a roadway on which the vehicle is traveling using at least one camera installed on the vehicle;
receiving geographical roadway map data that includes one or more roadways including the roadway on which the vehicle is traveling;
obtaining vehicle dynamics information including a vehicle speed and a vehicle heading; and
adjusting the geographical coordinates of the vehicle based on the lateral ground displacement and the geographical map data, wherein the adjusting includes using an extended Kalman filter to calculate new geographical coordinates based on the geographical coordinates, the vehicle dynamics information, and the vehicle lateral displacement.

12. The method of claim 11, wherein the determining step includes:
obtaining images of the roadway on which the vehicle is traveling using a first one of the at least one camera that is installed on the vehicle as part of vehicle electronics; and
processing the obtained images to determine the lateral ground displacement of the vehicle within the roadway on which the vehicle is traveling, wherein the processing includes identifying lane markers or an edge of the roadway on which the vehicle is traveling.

13. The method of claim 11, further comprising the step of applying geo-shifting to the geographical coordinates before the adjusting step.

14. The method of claim 13, wherein the geo-shifting is imposed by a jurisdiction in which the vehicle is located.

15. The method of claim 11, further comprising the step of obtaining vehicle dynamics information including vehicle speed information and vehicle heading information, wherein the adjusting step is based on the vehicle dynamics information.

16. The method of claim 15, wherein the vehicle dynamics information further includes vehicle acceleration information and wherein the vehicle speed information is based on a vehicle wheel speed and/or a vehicle transverse speed.

17. The method of claim 11, further comprising the steps of:
sending the geographical coordinates or other geographical location information to a remote server; and
receiving update geographical roadway map data from the remote server.

18. A vehicle electronics system, comprising:
a global navigation satellite system (GNSS) receiver that is configured to receive GNSS signals from a constellation of GNSS satellites and to determine geographical coordinates based on the GNSS signals;
at least one camera that is configured to capture images of the roadway;
a wireless communications device that includes a processing device and memory, wherein the wireless communications device is configured to receive geographical roadway map data from a remote facility;
wherein the vehicle electronics system is configured to:
determine a lateral ground displacement within a roadway on which the vehicle is traveling by processing the captured images of the roadway; and
adjust the geographical coordinates of the vehicle based on the lateral ground displacement and the geographical roadway map data.

19. The vehicle electronics system of claim 18, further comprising a body control module that is configured to receive vehicle dynamics information from at least one of the following: a wheel speed sensor that is coupled to a wheel of the vehicle, a steering wheel angle sensor, a yaw rate sensor, and/or a throttle position sensor; and wherein the vehicle electronics system is further configured to adjust the geographical coordinates based on the vehicle dynamics information.

20. The vehicle electronics system of claim 19, wherein the GNSS receiver is further configured to perform geo-shifting techniques on the geographical coordinates as imposed by a government of a geopolitical region in which the vehicle is located.
